(19) United States
(12) Patent Application Publication
(10) Pub. No.: US 2003/0171111 A1
(43) Pub. Date: Sep. 11, 2003

(54) Cellular telephone interface apparatus and methods

(76) Inventor: Tim Clark, Moss Beach, CA (US)

Correspondence Address: J MARK HOLLAND & ASSOCIATES, 3 CIVIC PLAZA SUITE 210, NEWPORT BEACH, CA, 92660

(21) Appl. No.: 10/353,312

(22) Filed: Jan. 29, 2003

Related U.S. Application Data
(60) Provisional application No. 60/353,852, filed on Jan. 29, 2002.

(51) Int. Cl. H04Q 7/20

(52) U.S. Cl. 455/414.1; 455/457

(57) ABSTRACT

Apparatus and methods include a first data communication link (hardwired or wireless) between a sensor and an Internet communication interface or device (such as a Java™-enabled or other programmable cellular telephone). The cellular telephone can provide an always-on link to a network such as the Internet, on which websites and related hardware and software tools can permit ready and virtually unlimited access to and interaction with the original data and sensor, and/or the sensor's system. In the preferred embodiment, a Java™-enabled cellular telephone interfaces directly with one or more sensors as well as with a network such as the Internet, to provide a data acquisition and control channel. The cellular telephone's display and keypad can provide a local display and data entry for the sensor and/or the sensor's system.

### RELATED APPLICATIONS

Pursuant to 35 U.S.C. § 119(e) and any other applicable provisions, this application hereby claims priority to U.S. patent application Serial No. 60/353,852, filed on Jan. 29, 2002. The contents of U.S. patent application Ser. No. 60/353,852, and any other U.S. Patent or any other reference, if any, cited in this Application, are hereby incorporated herein by reference.

The present invention generally relates to data communication and control systems, and more specifically to electronic data acquisition, reporting and control apparatus and methods.

### BACKGROUND OF THE INVENTION

This invention is directed to data communication and control systems generally, and more specifically to electronic data acquisition, reporting, and control apparatus and methods. Among its many uses are real-time data acquisition, monitoring, and control for field servicing of machinery and systems, health care diagnostics (including monitoring vital signs or similar data for individual medical patients), and the like. In its preferred embodiment, the invention can connect a wide range of devices to the Internet through a cellular network, using a cellular telephone as a local service tool (i.e., a tool “local” to the device to be connected to the Internet).

A recent article in Sensors On-line magazine (www.sensorsmag.com, January 2002 ed., by Andrew Girson—“Intelligent Systems—Portable Handheld Devices, Wireless Communications, and Smart Sensors—What it All Means for Field Service”) provides an overview of certain available technology and its shortcomings (and some of the reasons for lack of further advancements in this technology).

Among other things, the author discusses the recent convergence of personal digital assistants (PDAs) and cellular telephone technology, as well as wireless data links. Those wireless data links can, for example, wirelessly interface with accelerometers and other sensors and transmit digitized measurements over a Bluetooth link up to 100 meters (Bluetooth currently is useful for relatively short-range wireless communication, such as communication with PCs, PDAs, printers, and digital cameras). Further regarding those wireless data links, the author also notes that “Oceana Sensor's ICHM 20/20 (see Photo 3) contains a Bluetooth transceiver and multiple channels of DA. The unit can be connected to sensors at one end of the wireless link and to handheld devices or other computers at the other end.”

The author then discusses “How Field Service May Change” in the future, and then sets forth in his Conclusion perhaps the most relevant paragraph in the article:

“How Field Service May Change: The idea that future sensors may be incorporated into networks of wired or wireless nodes is likely to have a significant impact on how portable, mobile, and remote sensing systems are created and maintained. In fact, the strong efforts of NIST and IEEE to rally the sensor industry around the 1451 standards and the lack of standardization in the overall handheld and wireless markets might lead to alternate conclusions regarding the future of handheld instruments, field service, and remote diagnostics.

¢One realistic possibility is that future handheld instruments won't be instruments at all, at least not in the classic sense of the word. Next-generation handheld instruments may be wireless data terminals, capable of interfacing with wireless smart sensors, retrieving data, graphing and analyzing results, and making recommendations.

“Consider Compaq's latest iPAQ handheld, complete with a standard Bluetooth link. No need to plug in a peripheral anymore to get wireless connectivity. And Microsoft is building Bluetooth support into its newest version of Windows CE. As wireless standards become ubiquitous, previous experience indicates that vertical market segments—such as test and measurement—will adopt them in force.

“And don't forget location-based technology, which has the possibility of dramatically altering the landscape of field service (see the sidebar, “Location-Based Services”). The FCC's recent efforts to mandate accurate location identification for all cellular phone users, and the large number of startup businesses devoted to providing location-based services will provide tremendous opportunities to automate field service in the areas of dispatching, fraud prevention, and diagnostics.

“Conclusion: Am I getting a little ahead of myself? Perhaps. But won't it be great when smart sensors can detect impending equipment failure and wireless links can transmit the information from remote sites to a maintenance panel? And wouldn't it be great if you could have a link to a local repair facility that could automatically negotiate a time to send someone out to the site with the right replacement parts at precisely the scheduled time? Hey, a guy can dream, can't he?”

As set forth below, the future is here, and the author's dreams have been realized, in the technology and invention described herein.

The limitations of existing technology of which the inventor is aware support the views of that Sensors On-line magazine author. For example, Gecko Electronics of Ontario, Canada offers a PalmOS™-based Service and Diagnostic tool (Pocket-tek) for use with their line of spa controls (see http://www.pocket-tek.com/). Gecko advertises Pocket-tek as a:

“ . . . high-tech personal digital assistant, which is going to change the way you service spas. It is the future of spa servicing today, but you can just think of it as your handy “pocket” technician! Simply follow the steps to set up your Palm m100, register your Palm m100 and Pocket-tek, download ServSoft software to your Palm m100, and you're ready to go!”

“Simply put, the IR (infrared) beam from your handheld Palm m100 communicates with the ADIR-1 communication cartridge that easily inserts into Gecko's latest model MSPA-MP spa packs. Pocket-tek technology will enable you to do many things, just a few of which are: output testing, downloading software updates, programming system settings, troubleshooting wirelessly, etc. You will soon find Pocket-tek to be a truly practical service tool.”

Similarly, there are many existing players in the arena of automotive scan tools, none of which have moved into the “future” for which the Sensors Magazine author dreams. These include manufacturer's of expensive factory-service center scan tools, all the way down to companies that deliver PalmOS™ based solutions for the car-owner (similar to Gecko's Pocket-tek described above). Examples include: Ease Diagnostics (http://www.easesim.com/, offering PalmOS™ and PocketPC™ based applications); ALLDATA (http://www.alldata.com/, an on-line provider of Automotive Service and Diagnostic Information, using a DIY (do-it-yourself) subscription for car-owners); and AutoTap (http://www.autotap.com/, a maker of dedicated ScanTools for both consumer and Service Center applications). A further list of some of the companies doing OBD scan tools is at the website http://www.elmelectronics.com/Misc/OBDInfo.html.

Further, companies such as OnStar™ and NetworkCar™, have developed in-car diagnostic monitoring capabilities using embedded cellular modem, and two-way paging technology. Among other things, the communications interfaces (cellular modem or two-way pager) are permanently embedded within the specific, single automobile (and therefore are not readily transportable from one vehicle to another)—and are dedicated to the particular task of delivering On-Board-Diagnostics information to a remote observer (rather than providing any information to the local user). In other words, there is no display of any information to the local user (e.g., the driver of the car), and effectively no provision of the information to the end user/driver.

Similar shortcomings exist in the world of health/medical monitoring. Many companies already provide systems/tools for “localized” monitoring, where the burden of monitoring is put on the end-user/patient himself (such as a cardiac rehabilitation patient). In some existing systems, the patient can even “upload” and store the data through the patient's computer or telephone line to a location where the hospital staff is able to view it. Examples of such systems include: Agilent Technology (formerly Hewlett Packard's Medical Instrumentation division) (http://www.agilent.com/, a leading manufacturer of medical equipment, including in-home monitoring equipment); Beckman Medical (http://www.beckman.com/, another leading manufacturer of medical equipment); TransMedX (http://www.transmedex.com/products/product007.shtml, whose Telemetry@Home technology provides wireless in-home monitoring of cardiac parameters); and Polar CIC (http://www.polar.fi/, a maker of personal heart-rate monitors).

Although these systems are improvements over preceding technology, they do not provide numerous benefits in the present invention.

Some very recent developments in cellular telephone technology include certain programmability of the phones, such as by using JAVA applets and programming (see, for example, Nextel's website (i85s, i50sx, i90c) Phone brochures. http://www.nextel.com/; and Motorola's iDEN Site, https://idenonline.motorola.com/ideveloper/index.cfm).

Objects and Advantages of the Invention:

It is, therefore, an object of the invention to provide a communication system, including a sensor; a communication device such as a cellular telephone configured to communicate data both with the sensor and with a network; and communication apparatus for the communication between the sensor and the cellular telephone.

Rather than requiring a new generation of sensors and hand-held devices to be designed, fabricated, adopted, etc., the invention can take existing sensors and, via a communication system such as JAVA™-enabled cellular telephones, directly receive that data into the telephone and use the telephone to transmit it to any location around the world, including a real-time transmission of the data to the Internet, to one or more selected sites on the Internet, etc. The “wireless” aspect of the system can therefore be the existing technology of cellular telephones, so that there is no need to wait for future wireless sensors, etc.

A preferred Internet Embedded Resource Manager (ERM) Server architecture, capable of supporting a network of said configured cellular telephones is also disclosed. Persons of ordinary skill in the art will understand that this is one of many possible Server architectures which could support a network of cellular service tools, including products offered by Axeda (http://www.axeda.com), and emWare (http://www.emware.com/).

Persons of ordinary skill in the art will understand that the instant invention can certainly also be used with future wireless sensor technologies (so that, as mentioned in the Sensors Magazine On-line article, data can be transmitted wirelessly from the sensor to a hand-held device, such as a PDA or cellular telephone).

Other objects and advantages of the invention will be apparent from the following specification and the accompanying drawings, which are for the purpose of illustration only.

### BRIEF DESCRIPTION OF THE DRAWINGS

FIG. 1 is a graphical block diagram illustrating one of the many embodiments of the invention, as it might be used with on-board data and diagnostics on an automobile;

FIGS. 1a-h are PowerPoint slides from a proposed presentation regarding the invention, with 1a and 1b being two pieces of a single flow chart illustrating a preferred display sequence on the cellular phone device of the invention, 1c providing further information on the invention, 1d-1g illustrating some of the many graphical displays that can be generated from the data such as on a remote viewer, and 1h being a copy of FIG. 1 above;

FIG. 2 is similar to FIG. 1, but graphically illustrates another of the many applications for the invention, as it might be used to remotely monitor and control a swimming pool or spa. As one of the many alternatives for communicating with the preferred ERM Server (described below), this FIG. 2 shows two channels for communication—a wireless pager transmission to the Internet, and a serial channel communicating with an embedded gateway to the Internet. Person of ordinary skill in the art will understand that various aspects of the invention can be practiced by substituting a cellular telephone device (such as discussed elsewhere herein) instead of those channels (similar to the approach illustrated in FIG. 1), to bring many of the benefits described herein;

FIG. 3 illustrates one of the many alternative local user interfaces (displayed on the cellular telephone device) that can be provided by the selected hardware/software of any particular embodiment of the invention. A series of menu screens can permit a user to monitor and control many aspects of a system locally. In this Figure, the menus relate to a system such as the pool/spa of FIG. 2. The preferred cellular telephone device includes an input mechanism such as a keypad for interacting with the monitored or controlled system (although useful with the cell phone's display, even if no display is provided or active on the cell phone, the keypad could be used to control the system, such as by using a plastic “command” template placed over the keyboard);

FIGS. 4A and 4B are similar to FIGS. 1d-g above in their function, but illustrate some of the many displays that can be provided on a remote viewer for spa (FIG. 4A) and pool (FIG. 4B) applications;

FIG. 5 illustrates a preferred embodiment of a network architecture, which can be used to implement the present invention. The web-enabled cellular telephone 50 preferably functions as described elsewhere herein (including being capable of itself being directly connected to a sensor/control device, not shown in FIG. 5). Other data collection/control nodes or devices 60 may be provided with other communication paths 70 to the Server, and those other nodes 60 may be monitored and controlled by, among other things, the cellular telephone;

FIG. 6 is a data-flow diagram of a preferred software architecture for the present invention;

FIG. 7 is a software flowchart for a preferred ERMMonitor application, which runs on the ERM Server—accepting UDP datagrams from the remote embedded Gateway devices; and

FIG. 8 is a software flowchart for a preferred ERMControl application, which runs on the ERM Server—managing Control to and from the remote embedded control devices.

### DESCRIPTION OF PREFERRED EMBODIMENT

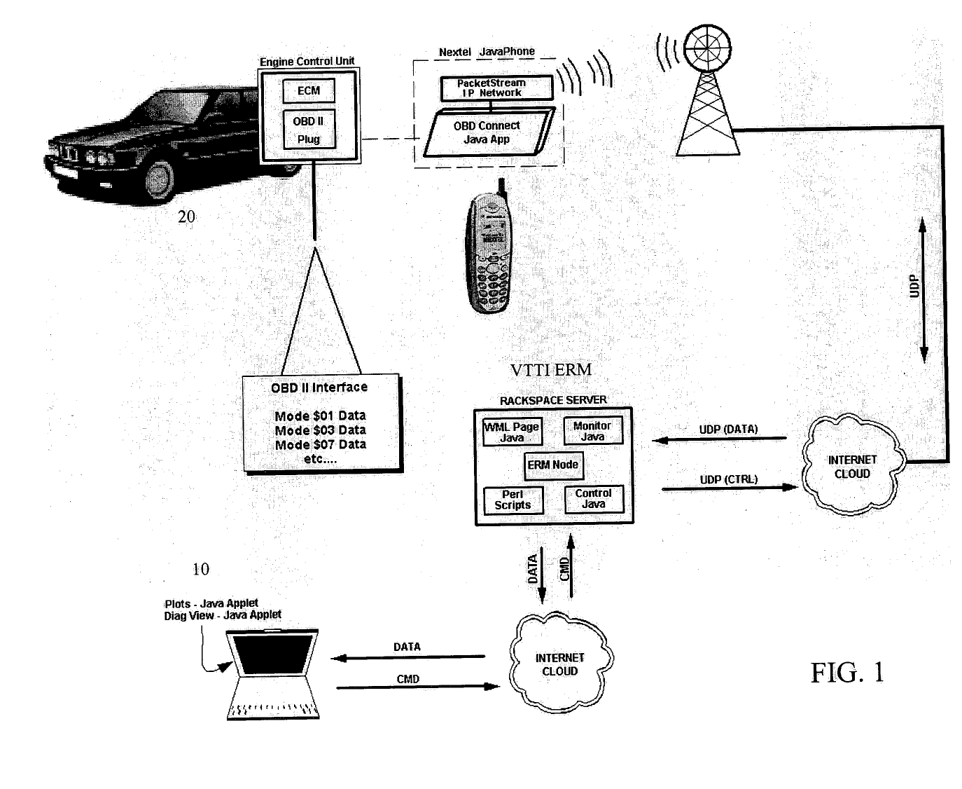

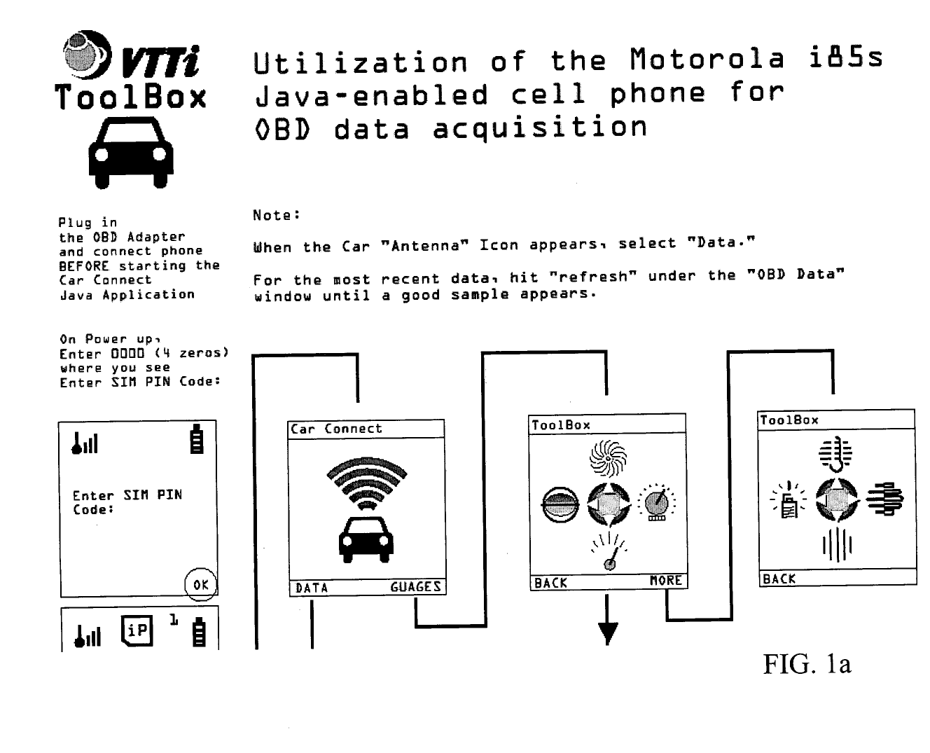

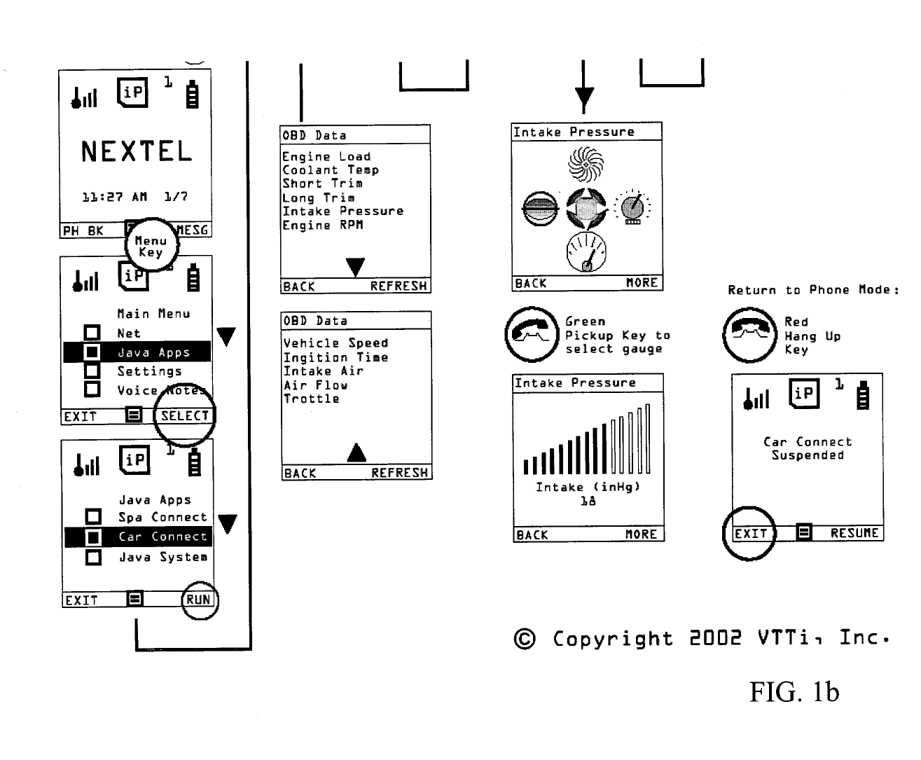

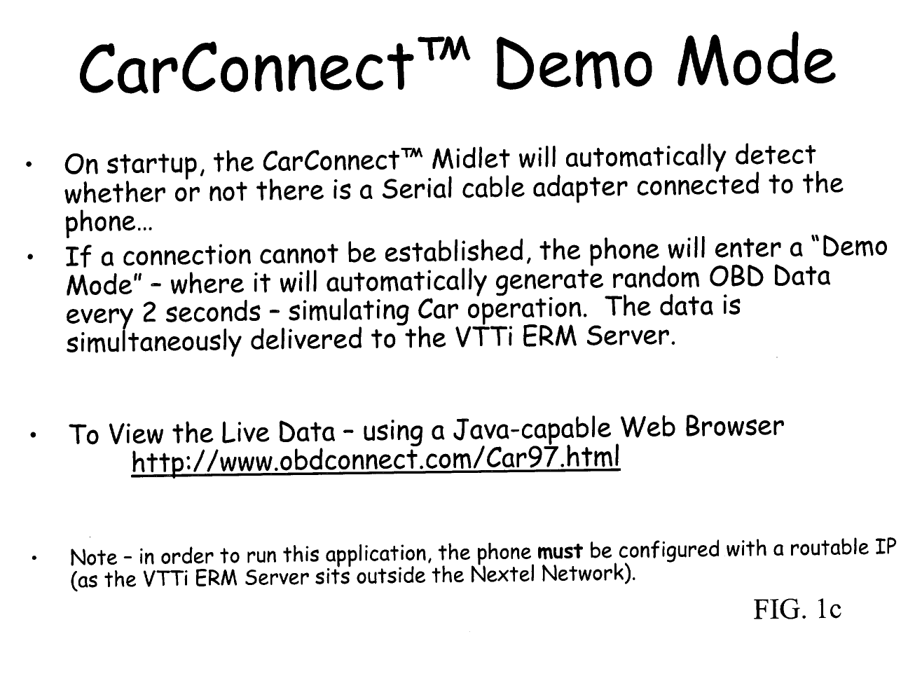

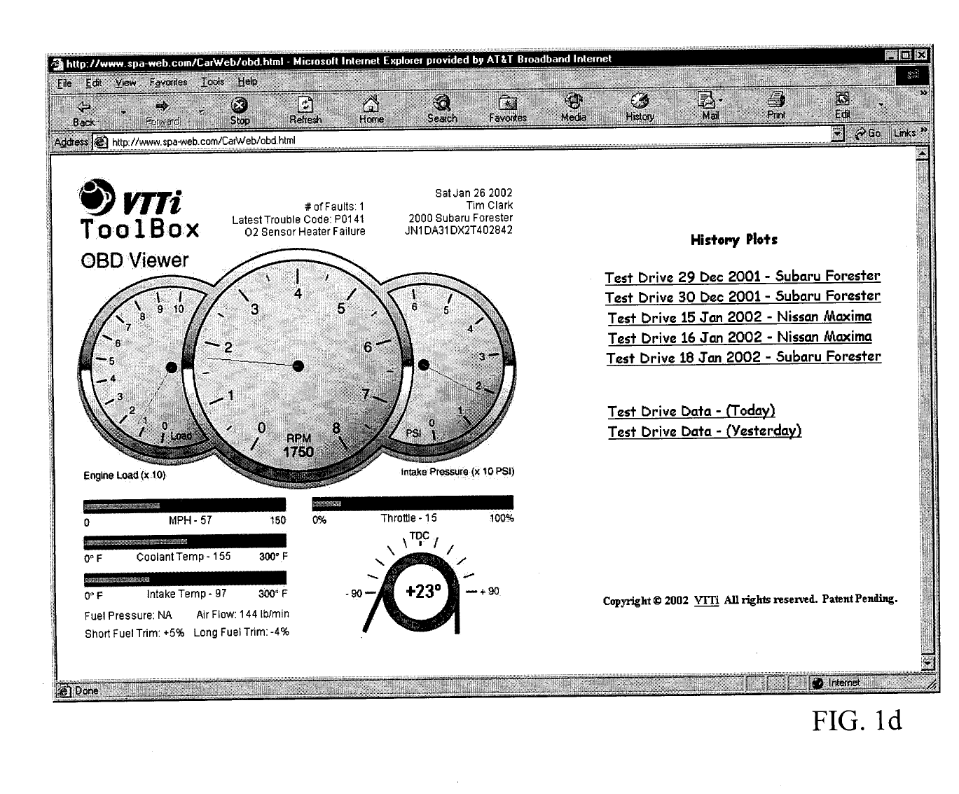

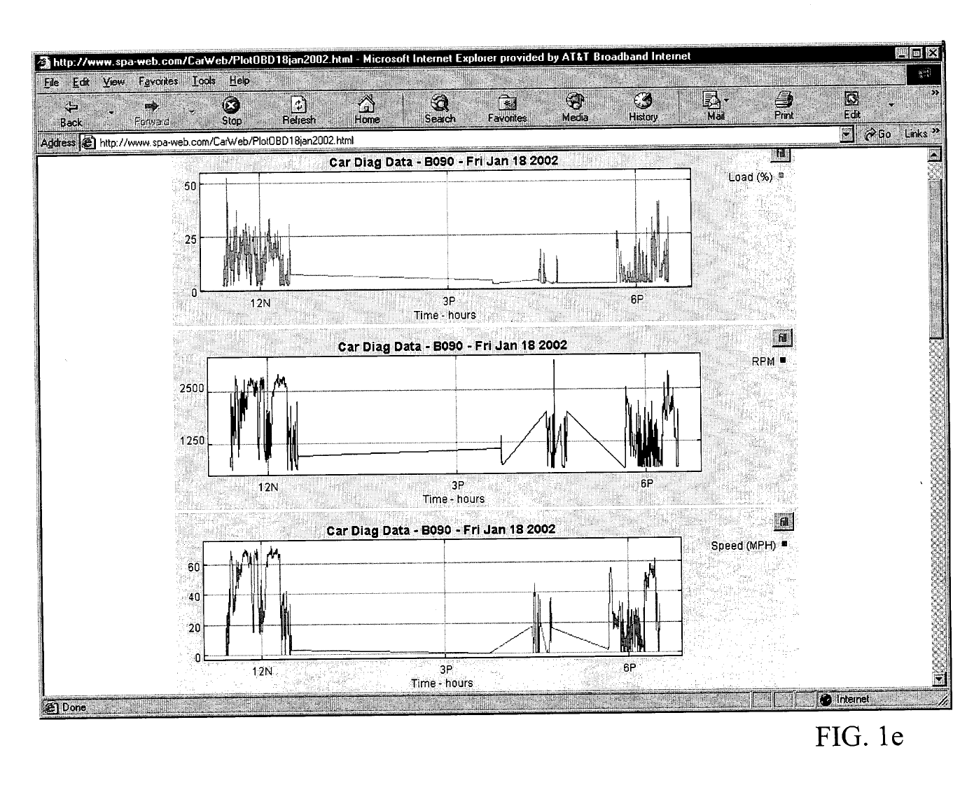

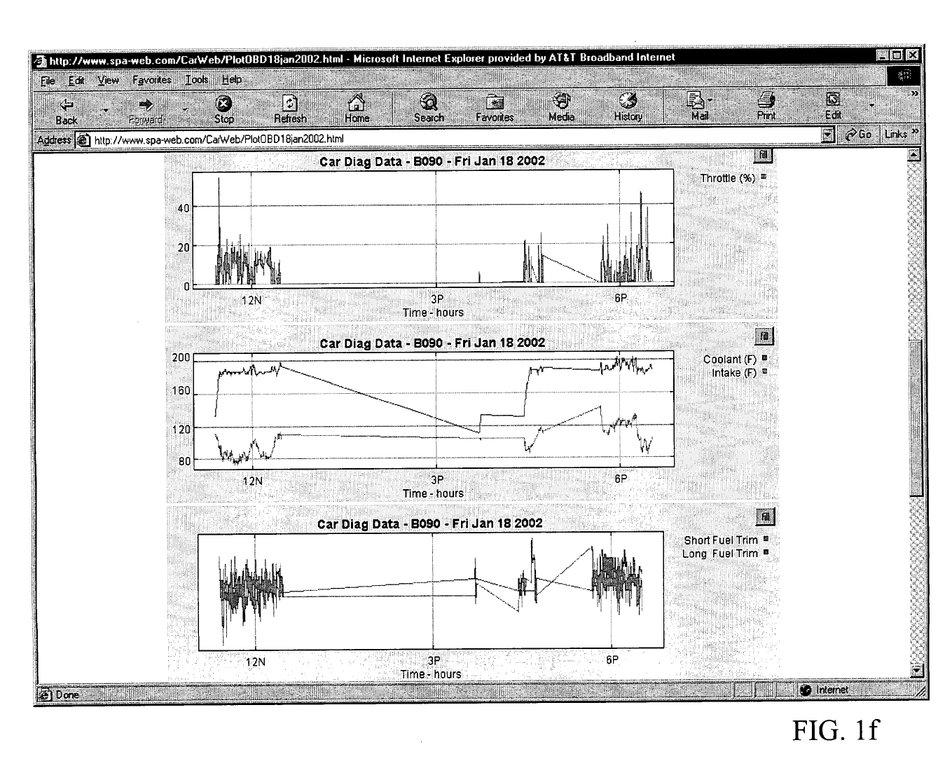

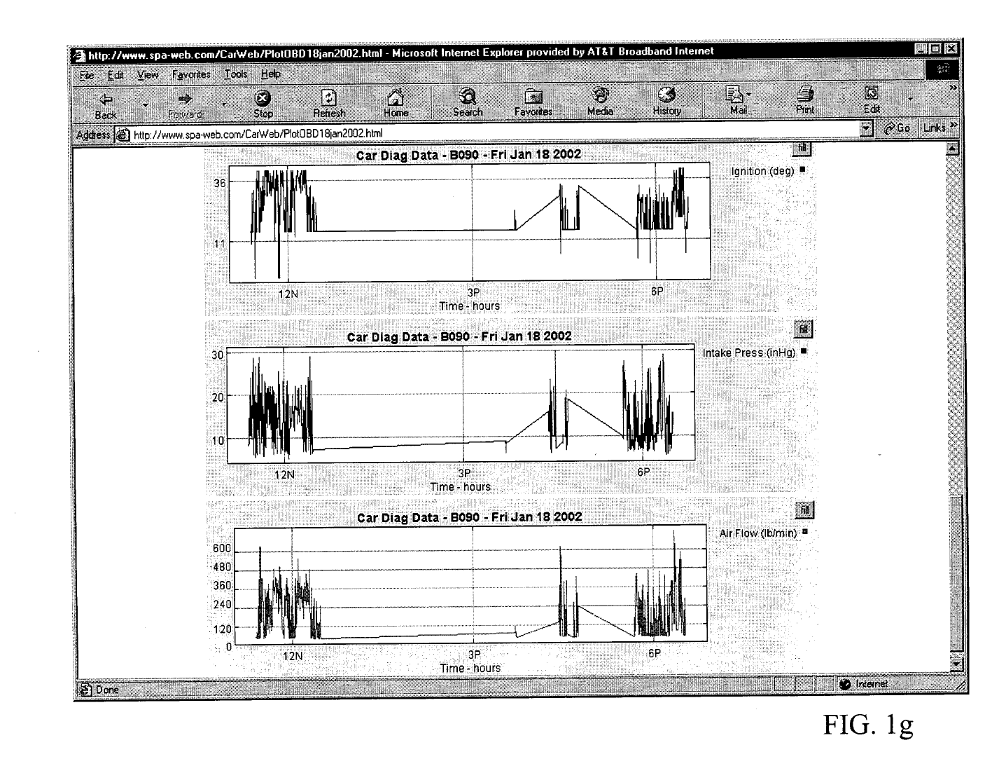

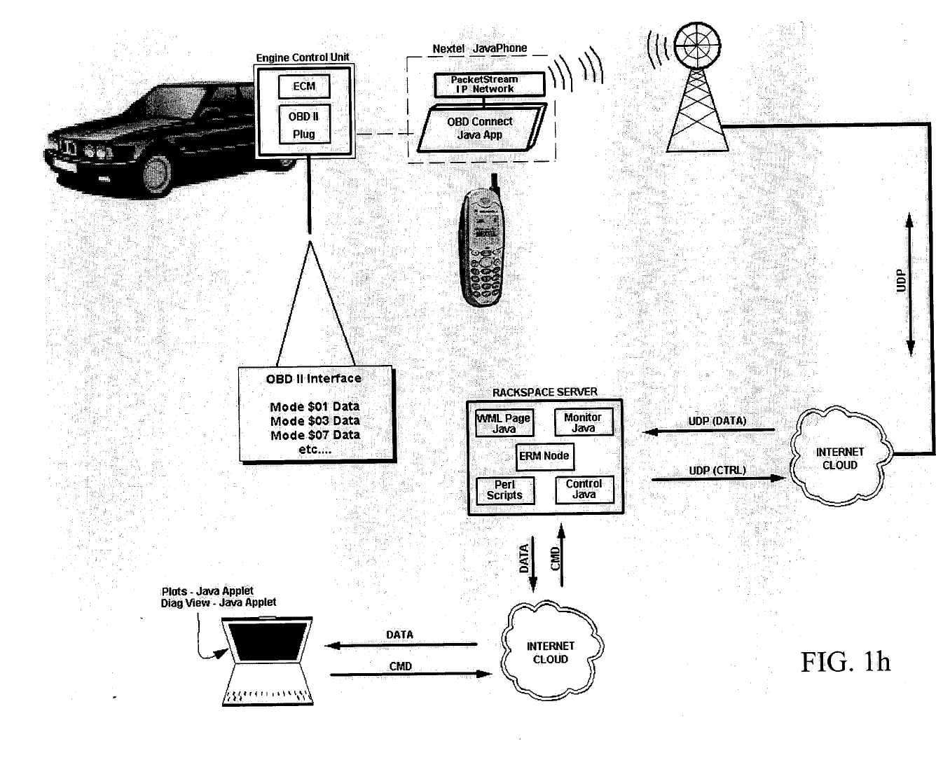

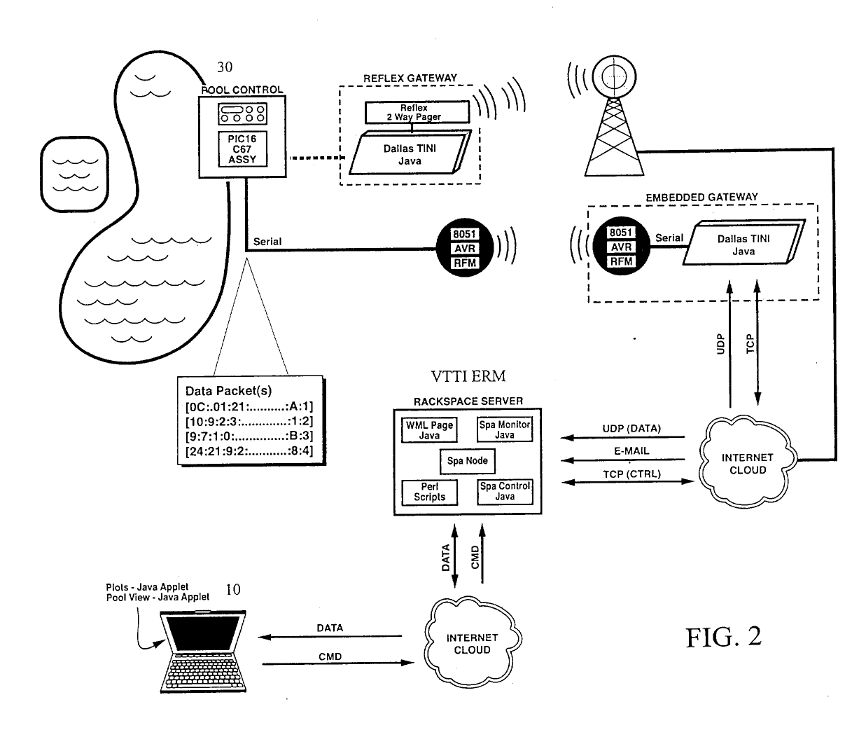

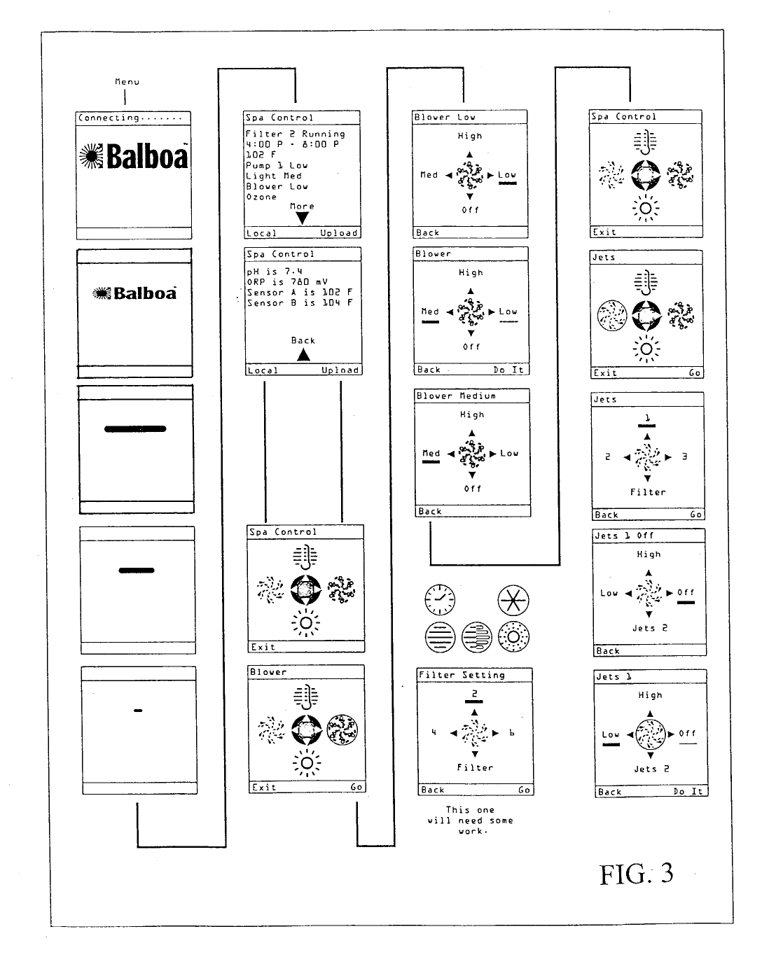

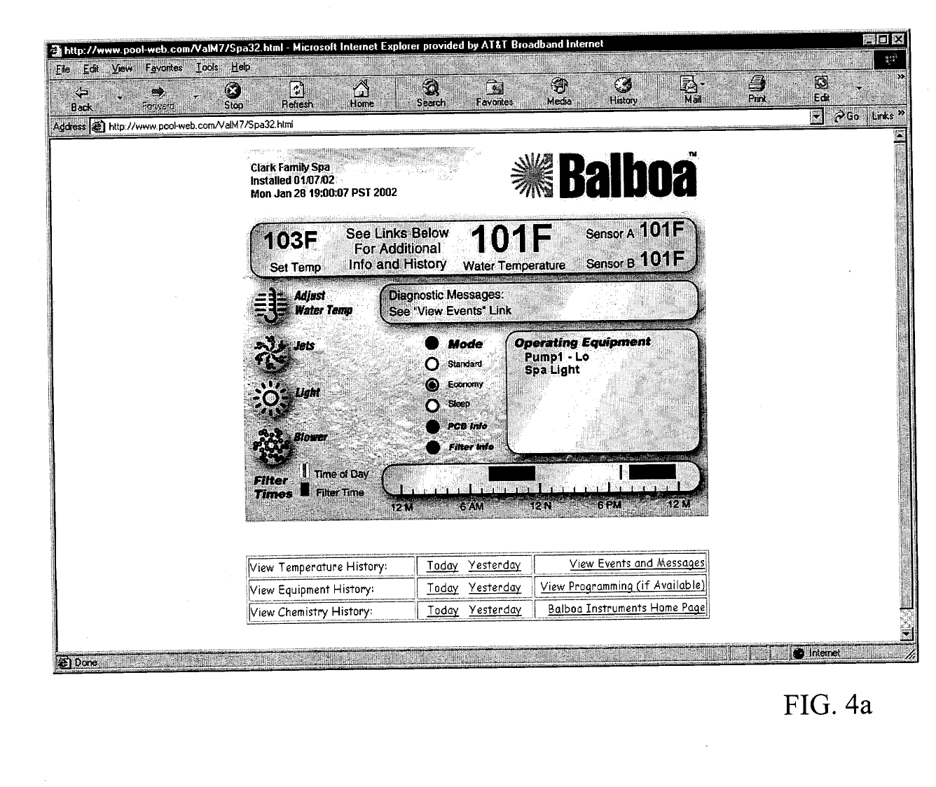

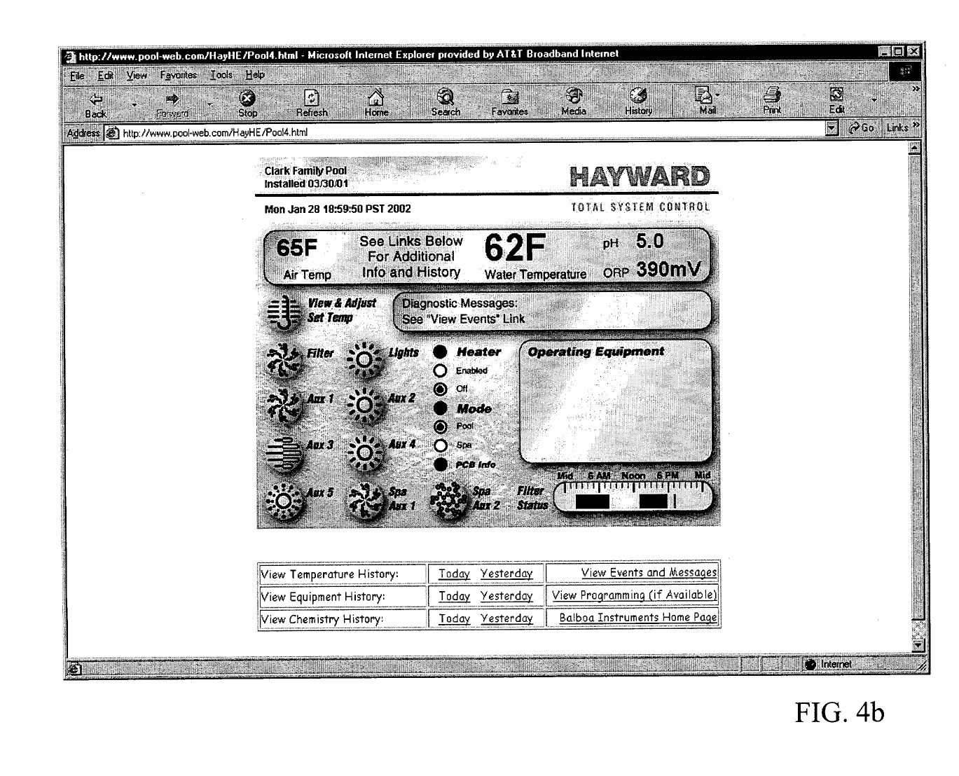

A preferred embodiment of the invention is generally illustrated in FIGS. 1-3, with FIG. 1 illustrating use of the invention in connection with automobile data, and FIGS. 2 and 3 illustrating use in connection with a spa/pool application. Persons of ordinary skill in the art will understand that the various components and methods can be of any suitable brand and nature, so long as they provide the desired functionality described herein.

In general terms, the preferred embodiment of the invention includes a combination of hardware and software to allow real-time transmission of data being generated by a system (even one such as the human body), using a device such as a cellular telephone. The preferred embodiment permits remote viewing and communication/control with the site/application from which the data originates.

Persons of ordinary skill in the art will understand that the preferred cellular telephone component or device useful in the invention can be provided by programmable cellular telephones (such as those discussed herein), but could also be provided by other devices and technologies. Wireless pagers as well as other technologies, can provide the preferred cellular networks that cover the vast majority of the planet, thereby making the invention easy to use, without the end-user having to create any communication infrastructure to get to and from the Internet.

Preferably, the cellular telephone or similar device provides an Internet communication interface, while connected (via hardwiring or wirelessly) to a “live” sensor/controller device in the monitored/controlled system. Depending on the application, the sensor/controller device can be any of a wide range of devices, capable of reporting data, controlling the system, or both.

Also preferably, the invention includes a suite of hardware and software products provided for use on programmable cellular telephones or similar devices, such as the family of Nextel/Motorola Java™-Powered phones (e.g., model i85s). Among other things, the invention preferably enables the cellular telephone to interface directly with a wide variety of devices, so that it can function as a Service/Diagnostic/Monitoring device. In the preferred embodiment, the invention turns the phone into a powerful, highly configurable test tool.

To enable the desired communication with a sensor/control device, the attached “device” preferably is in communication with the cell phone's built-in serial port (using appropriate serial communication parameters—baud rate, stop bits, parity, etc). If a particular attached “device(s)” does not support a standard serial interface, an adapter apparatus (such as a cable, connector, box, etc.) can readily be provided and used to suitably create a suitable “serial” connection between the cell phone and the “device”. (Note that the serial port on the cellular phone is traditionally used for a wired connection to a PC or Laptop computer—both for purposes of uploading software applications to the phone, as well as acting as a cellular modem connection to the Internet, for the attached computer).

By way of example, in a specific embodiment such as the automotive application discussed herein, an Adapter Cable and suitable RS232 OBD protocol conversion circuitry is required to establish communication between the phone and the vehicle's industry “standard” J1962 OBD Connector. Among other existing resources available to persons of ordinary skill in the art, the SAE (Society of Automotive Engineers) provides ample information to understand and construct such an adapter (similar principles and resources can readily be used in fabricating and providing other adapters/hardware/software for applications other than automobiles OBD data).

On a related point, persons of ordinary skill in the art will understand that, as other communication channels (other than the serial ports now available on current cell phones) become available, the invention can be readily practiced using those other “non-serial” interface channels from the device to the phone.

The cellular telephone preferably also functions as an Internet Gateway, delivering all or selected available data, in real-time, to a website/server such as the VTTi ERM (Embedded Resource Manager) server. The data can be permanently and securely stored in an on-line database there, accessed from any Web Browser by a user having sufficient permissions (passwords, etc.). The ERM Viewer, FIG. 3, provides a real-time graphical interface through a suite of Java™ Applets, allowing someone at a remote site (such as a remote computer 10, FIGS. 1 and 2) to “see” everything that the on-site service technician is seeing (at, for example, location 20, FIG. 1 or location 30, FIG. 2), and, in some cases more (see discussion elsewhere regarding the “more” that can be seen by a remote viewer, for virtually any application of the invention).

If desired, a cellular telephone can even be left “permanently” connected to the monitored device (such as at locations 20 or 30), saving travel, hookup, and other time and expenses. Remote commands preferably are supported through the ERM Control server delivering the appropriate command information to the remotely connected device through the cellular telephone. Plotting Applets allow for Web-based viewing of all logged data, over any specified time interval, providing great flexibility in analysis.

In a preferred configuration for Automotive On Board Diagnostics, FIG. 1, the cellular telephone is programmed to communicate with any vehicle through the OBD Connector, a connector that is required on all vehicles sold in the US since 1996 (typically, the vehicle's connector is located under the dashboard, making it fairly simple to connect and use the cell phone in this application, and thereby to even be able to gather data while actually driving somewhere and under varying conditions, as discussed herein). Persons of ordinary skill in the art will understand that many aspects and benefits of the invention can be practiced and realized by custom data connectors/collectors interfacing with the cellular telephone, rather that a “standard” connector such as the OBD. Even though the telephone's programming preferably is standard to interface with the OBD, that programming can be customized as may be needed/desired in any particular application. As for the preferred hardware to connect to the OBD Connector on any particular vehicle, there currently are three configurations of OBD Adapter Blocks needed to cover all types of vehicles (one works on Ford vehicles, one on GM, and one for all other vehicles). As indicated elsewhere, if Bluetooth or other short-range wireless communication technology is incorporated into the OBD “connection” on board the vehicle, the cellular phone can be configured (with proper hardware and software) to receive that wireless signal, rather than use any “adapter block” at all.

Preferably, the OBD Viewer software suite uses the OBD Connector connection to communicate a host of information, including Diagnostic Trouble Codes (DTC's), real-time vehicle performance data, and sensor status. The OBDConnect Java™ Midlet preferably delivers all the incoming OBD data to the cellular telephone user, again, through a series of Display Forms (see FIG. 3). Further support preferably is provided for graphing of selected real-time data (RPM, Vehicle Speed, Intake Temp, Ignition Time, etc) through a series of icons on the forms or other suitable user interface. For the remote display, a Browser-based Java™ Applet preferably provides a custom graphical user interface, delivering the information to the “remote” observer in a familiar “Gauge Cluster” display, along with any current Diagnostic Trouble Codes (DTCs), Vehicle Identification Number, and all available contact information for that particular individual. Support for remotely controlling parameters within the Engine Control Module (ECM) is provided through the ERM Control suite (including the ability for a Service Center to reset DTC's).

In a preferred Pool/Spa Service Tool configuration (FIG. 2), the cellular telephone is programmed to communicate with the on-board microprocessor powering the Pool/Spa Control (preferably in the form of a serial port on the Pool/Spa control, for which relevant communication specifications are typically available from each individual manufacturer—as mentioned above for the OBD data specifications)—supplying detailed operational and diagnostic information. Preferably, the SpaConnect™ Java™ Midlet delivers all the incoming data to the on-site Service Technician through a series of Display Forms shown on the cell phone. Control is supported through a series of icons on those forms, representing the different functions found on a Pool or Spa Control (Jets On/Off, Blower On/Off, Spa Lite On/Off, Filter Settings, etc). For the remote viewer/display, a Browser-based Java™ Applet provides a customized graphical user interface, delivering the information to the “remote” observer in a clear and concise fashion—with support for many sophisticated command and diagnostic routines. Persons of ordinary skill in the art will understand that, among other things, the invention can include real-time downloading of new or updated firmware for the system being controlled/monitored (in addition to downloads of applications and new software to the phone itself), via the Web—using the cell phone.

Persons of ordinary skill in the art will understand that the preferred apparatus and methods of the invention can be used in many other applications, systems, and processes. In addition, if desired, a preferred single cellular telephone can simultaneously hold programming so that it is capable of functioning in a plurality of such applications, without further or multiple downloads of programming (such as Java applets) to the cellular phone. The number of programs/devices with which the cellular phone is capable of interfacing/monitoring/controlling is limited by the memory storage within the cellular phone, but current phones could readily hold 10-15 such programs, and future (increased memory) phone devices will presumably be able to hold even more. Consequently, and by way of example, one telephone preferably could be used (at the user's election, and subject to the user's control) for (1) communication with devices at the user's home (such as a spa/pool/kitchen equipment/heater/AC/lights), (2) to send data to the user's doctor (regarding the user's health and/or vital signs or other diagnostic information), and (3) to communicate data about the user's automobile (such as to a car dealer or service shop). Thus, a single user could be a Pool/Spa service technician (using the phone in connection with onsite service work), who also is a cardiac rehab patient (using the phone to provide alerts and data to his health care center), who also likes keeping an eye on the diagnostic codes are on his or her car (using the phone as described above to monitor the car's OBD data). With current operating systems, and serial port limitations, only one such application can be run at any given time, although future operating systems and connectivity mechanisms (including Bluetooth), may permit multiple systems to be monitored/controlled simultaneously by a single telephone.

In addition, for those embodiments using a cellular telephone, there is no need for the user (such as a field technician) to buy yet another costly, separate piece of communication equipment (and to pay monthly service/access fees for the cellular or other communication service). Instead, the user can leverage the investment they have already made in their cellular telephone.

Further leveraging the Internet access provided by the invention, such as through cellular telephones using the Nextel network, the invention can deliver a whole host of services (data logging, remote access, automatic alerts, etc.) that are not possible using other devices or technologies, let alone across such a wide array of applications.

Thus, the present invention provides numerous advantages over any existing technology of which the inventor is aware. For example, regarding the Gecko Electronics Palm OS™-based spa tool (Pocket-tek) discussed above, the invention can not only provide all the functionality of the Gecko tool, but provides a remote user or users with a real-time remote window into all of the data an onsite user can see, and more. By way of example, if the onsite user is using a currently available cellular telephone with its relatively small display screen (approximately 100×85 pixel black/white display), the “Remote Engineer/Tech Support/Observer” person (viewing the data/system on a relatively much larger display such as a PC) can “see” more than can be displayed in the smaller cell phone display. The “remote” viewing device (such as a PC) is therefore capable of more as a User Interface device than is the Cell Phone. For instance, the “Remote Observer” preferably can access any/all historical data and have it displayed on the “remote viewing device” in the form of a graphical history plot, and can even print it out. As cell phones and similar devices advance, the differences in capability (between the somewhat “limited” interface of current cell phones versus the more capable interface of current PCs) may diminish, but other benefits of the invention will continue.

Similarly, in the arena of automotive scan tools, the invention can provide a service technician (whether a car dealer, a service center, a gas station, or otherwise) or even a car owner himself with all the functionality of the existing tools mentioned above, but (as with the spa tool) with a suite of Internet technology tools to provide a real-time remote window into all the data the on-site person is seeing, and more (similar to the “more” discussed above). Perhaps more importantly, the invention permits the user, technician, or even the manufacturer to take a “test drive” at any time, with the vehicle continuously transmitting all on-board diagnostic data to any selected destination, such as a secure Internet website. The data can be stored there or viewed in real time, and in any case can include a mechanism for “tagging” the data at relevant points in time—for those nasty “only-happens-when-I'm-driving” glitches, noises, and rumbles—so that the service technician can easily see what was going on at the time of the problem.

Additional applications of the invention in the automobile industry are virtually unlimited. Lube shops can use the invention to provide vehicle diagnostic scans with almost no expense on software or hardware infrastructure—hypothetically charging an extra fee for a 27-point Diagnostic Scan.

Likewise, independent service shops can have access to all current manufacturers' data, without the purchase of a separate ScanTool (approximately $2500 each currently) from every auto maker, with no need for make-model-specific software. The Low cost of equipment (a Nextel-type phone plus an OBD adapter) allows the shop to purchase only one scan tool, or at most, one per auto bay, and to use the tool out in the parking lot, on-site (if called out to a vehicle that has stopped running), or the like. The speed, efficiency, and quality of service can be improved, because all manufacturer-specific data can be displayed in their “current” form, as well as permitting the immediate selection and display (back to the service technician) of any recalls, warnings, or similar information relevant to the vehicle being tested, all via the ERM Internet server. In some or many of these situations, the “remote” viewer might actually be right beside the vehicle in the auto bay where it is being serviced, in the form of a PC logged onto the Internet server site that is receiving the real-time data from the vehicle.

Yet another application of the invention regarding automobiles is automobile racing. Sports such as NASCAR can create a revenue stream where one currently does not exist, and provides an Off-Track “Fan” experience, by monitoring and displaying relevant data from various race cars over the Internet, to subscribing customers. Race car fans can thereby have a much deeper insight and involvement in the race they are watching, or the broadcast of the race may be displayed in an adjacent window in the fan's browser, etc.

Automobile dealer service centers can achieve a better quality and more efficient result, as well as a faster turnover rate for their auto bays and equipment. The invention permits the Service Center access to vehicle diagnostic information/trip data prior to the customer's arrival, thereby allowing the dealer to get a better handle on the potential problem, check parts availability, etc. Loyalty to the dealer can be increased as well, if (for example) at the time of new/used vehicle purchase, the buyer is shown a demo of the invention application running on the cellular phone—highlighting the active role the Dealer Service Center can play in the care and maintenance of the buyer's car.

As indicated above, car owners can use the invention to perform diagnostic scans on their cars at any time, saving between $50-$150 a pop (depending on where/when the scan/servicing would otherwise be done), and also creating accountability for any repairs that are eventually made to the car. Car owner end-users of the invention normally will require very minimal integration/support to adopt and use the invention. By way of example, each user can register online (through either a website such as the NASCAR site, Snap-On, etc. or directly on the invention's Internet Server website), where they will setup an account, and ultimately create their own Personal Car Web Page—with Live View, and History Display. All support to the car owner can be handled through the respective Web Site—via FAQ's, Tutorials, and Problem Report forms.

As also mentioned above, historical data can also be archived and retrieved (such as in an on-line database maintained on the Internet or otherwise) for any of the applications (automobile or otherwise) discussed herein. The availability of this information can permit much more effective use of time and resources.

In the field of medical/health monitoring/reporting/analysis, again there are many companies providing localized solutions, where the burden of monitoring is put on the enduser (to monitor, store, and/or upload the relevant vital signs or other data). Among the benefits of the present invention are: (1) it can provide a real-time, continuous uplink of the monitored data via the patient's cellular telephone, securely delivering all the encrypted medical monitoring data for viewing by a physician or other medical personnel from any available Web browser; (2) in that same Web browser, the medical personnel may also instantly pull up not only the real-time data that is being generated by the patient, but also a graphical history of the patient's data; (3) support for “alert” or warning/dangerous conditions can also generate a real-time message/alert (such as an email and/or page) to the physician or appropriate medical personnel in the event of a serious condition; and (4) these and other aspects of the monitoring can be configurable through the Web-based interface.

By way of example, the telephone can be configured to interface with a commercially available Heart Rate Monitor and Temperature Sensor for remote monitoring of “discharged” Hospital patients (an example would be a Cardiac Rehab patient who has recently undergone bypass surgery, and has been discharged by his HMO, but put on a “restricted activity” regimen). Using the invention, the hospital can keep close tabs on the patient, including setting alerts that trigger if the patient's heart-rate exceeds a predetermined threshold. All data can be permanently logged into an online database, so that the physician is able to retrieve it for immediate analysis from any location (hospital, home, vacation, office, hotel room, etc.), thus providing a truly new level of patient care.

Further regarding benefits of the invention in health/medical applications, in embodiments in which the data is delivered from the patient using a network such as Nextel's, the patient can simply wear their chest strap heart-rate sensor (or other sensing device) connected to their cellular telephone, and the data will be continuously transmitted in real time. So long as the telephone is turned on, you do not have to “dial up” or call a number; the data can find its way to a desired website or location such as the ERM/Rackspace Server (see FIGS. 1 and 2). The patient is free to move about (take a walk, go to the store, return to the clinic for an exam) all with complete monitoring of their vitals.

Persons of ordinary skill in the art will understand that, in the preferred embodiment the cellular telephone component of the invention is used as a Local/On-Site Service/Diagnostic Tool, including using the cellular telephone's display screen. Although other technologies use a cellular telephone as a “modem” or otherwise use wireless modems to transmit data, the inventor is not aware of a cellular telephone previously being used as a Local/Service/Diagnostic Tool, especially while also being used as an “Internet Data Pipe”.

In addition to the benefits of the cellular telephone device providing an “Internet Data Pipe” and/or a cellular telephone connection to transmit the data/control commands, persons of ordinary skill in the art will understand that the preferred cellular phone of the invention preferably can provide many of the benefits herein even without any such connection from the phone to the Internet or to a cellular network. By way of example, even in such a “non-broadcasting” mode, the cellular phone can be used as a programmable, portable Local/Service/Diagnostic Tool, providing a user-friendly interface by which a service technician can extract relevant data, issue commands to the controlled/monitored system, etc. Under such conditions, the remote viewer would not be receiving data, but the local service technician can benefit from a powerful tool not presently available to him. Also under those conditions, the cell phone preferably is capable of storing the data for subsequent transmission (such as via the Internet or the cellular connection).

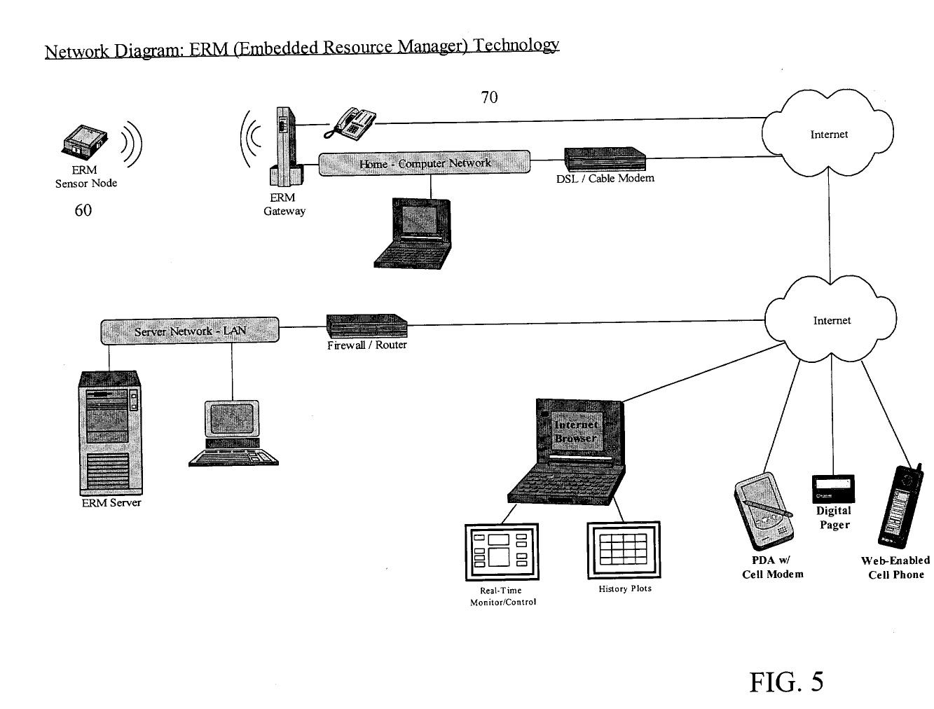

FIG. 5 illustrates a block diagram of a preferred remote monitoring and control system for a network of embedded sensors and control devices. The ERM technology provides an end-to-end solution, encompassing everything required for remote monitoring and control—from the ERM Sensor Node, the ERM Gateway, to the ERM Server, providing a central gateway for all end-user access.

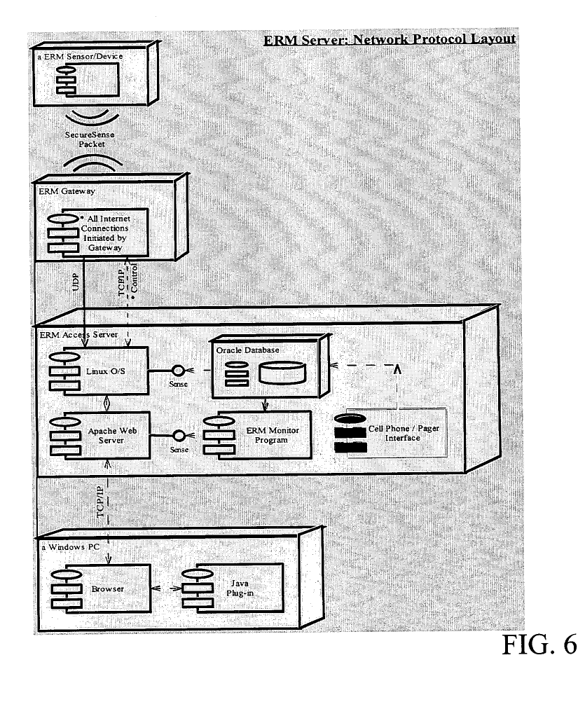

FIG. 6 depicts the data-flow of the preferred software architecture for the present invention—from the ERM sensor node, the embedded Gateway, then Central Server, and the end-user's Web browser. (Note that all connections to the Internet preferably are originated by the remote Gateway—thereby thwarting any remote attacks).

Persons of ordinary skill in the art will understand that the ERM Server can be suitably practiced on any number of computing platforms. A preferred embodiment is a 750 MHz Pentium III Computer, preferably running RedHat Linux version 7.0 or above, with a high-speed Internet connection. The preferred software infrastructure can be broken down into four (4) categories:

1. ERMMonitor—Java program, which handles incoming data from ERM installations (TIM's), Alerts, data storage in the Database, and all “live” Web Browser connections.

2. ERMControl—Java program, which handles “control” connections from Web Browser applet(s), queuing up and serving commands to ERM installations (TINI's).

3. WebScripts—Linux cron jobs, which run periodically to generate dynamic web content including Cell Phone Pages, Web Statistics, and Alert/Error Logs.

4. Database—a MySQL DB running on the same Linux box, maintaining a central repository for all incoming data.

In the preferred embodiment of the invention, all site-specific configuration information is accessed through Web pages on the ERM server, using CGI/Perl scripts, providing end-user access to things like Name, Address, Phone, E-Mail, Pager, Password, as well as access to user-specific/selectable options—Cell Phone Page, Alerts, etc.

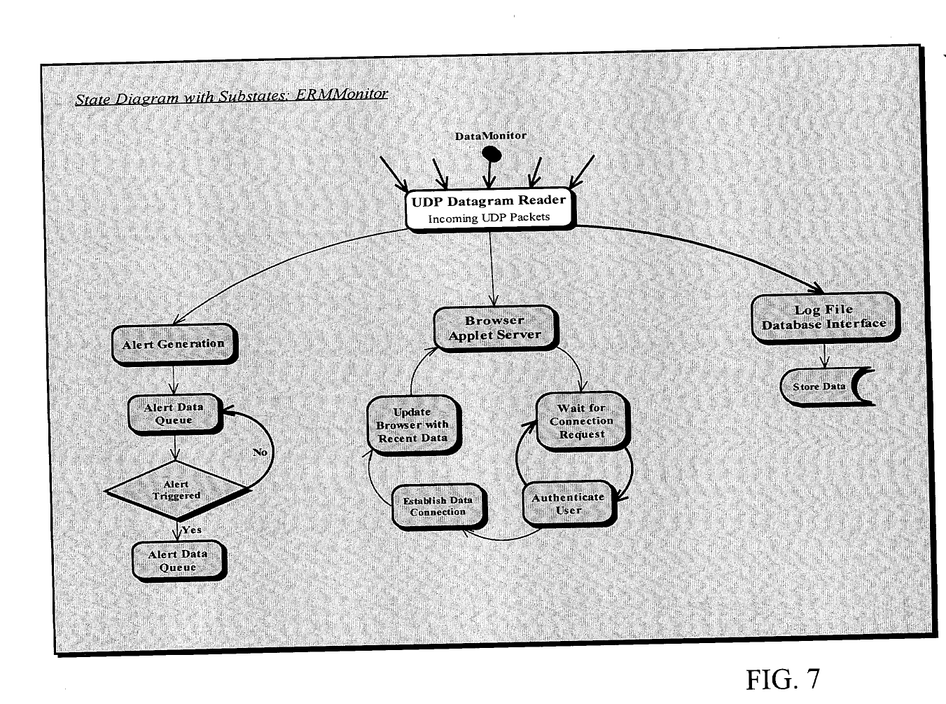

FIG. 7 is a software flowchart for a preferred ERMMonitor application, which runs on the EVCM Server—accepting UDP datagrams from the remote embedded Gateway devices. The UDP datagram is processed based on the stored configuration information—individually extracting each remote data block. The ERMMonitor application preferably then forwards the latest data to each of three (3) threads: 1. Log File/Database Storage; 2. Alert Generation/E-Mail Notification; and 3. Browser Applet Server.

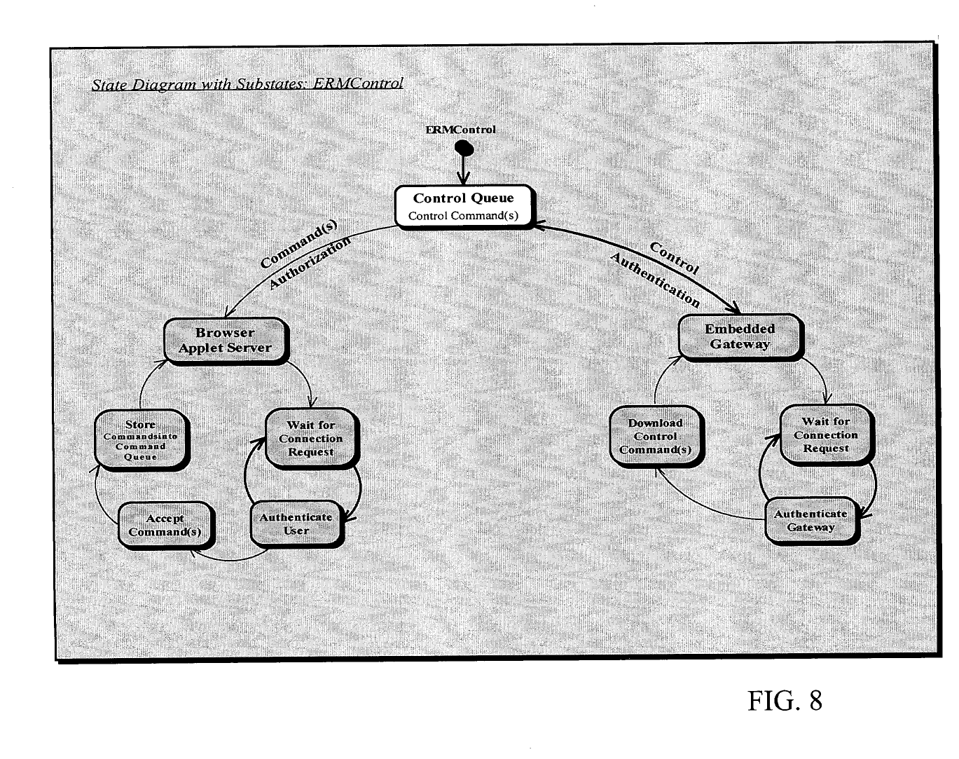

FIG. 8 is a software flowchart for a preferred ERMControl application, which runs on the ERM Server—managing Control to and from the remote embedded control devices. TCP socket connections from Web browser Java applets are accepted—providing a secure mechanism for authentication and authorization, prior to accepting any requested commands. TCP socket connections are also accepted from the remote embedded Gateway(s), where individual commands are extracted from the ControlQueue maintained on the ERM server.

The apparatus and methods of my invention have been described with some particularity, but the specific designs, constructions and steps disclosed are not to be taken as delimiting of the invention. Obvious modifications will make themselves apparent to persons of ordinary skill in the art, all of which will not depart from the essence of the invention and all such changes and modifications are intended to be encompassed within the appended claims.

I claim:

1. A communication system, including: a sensor/controller device communicating with a system to be monitored or controlled; a cellular telephone configured to communicate both with said sensor/controller device and with a network; and communication apparatus for said communication between said sensor/controller device and said cellular telephone.

2. The system of claim 1, in which said sensor/controller is comprised of an automobile equipped with an OBD2 diagnostic computer.

3. The system of claim 1, in which said sensor/controller is comprised of a portable ECG device.

4. The system of claim 1, in which said sensor/controller is comprised of an integrated GPS receiver, said integrated GPS receiver capable of providing latitude, longitude, altitude, and speed.

5. The system of claim 4, in which said integrated GPS receiver is for the purpose of vehicle tracking for remote diagnostics, troubleshooting, and repair.

6. The system of claim 1, in which said cellular telephone is Java™-enabled.

7. The system of claims 1, 2, 3, 4, 5, or 6, in which said cellular telephone includes an always-on link to said network, and said network is the Internet.

8. The system of claims 1, 2, 3, 4, 5, or 6, further including websites and related hardware and software tools to manipulate data.

9. The system of claim 1 or claim 2, said system including websites and related hardware and software tools to send commands to said sensor/controller device.

10. A method of monitoring a system remotely, including using the system of claims 1, 2, 3, 4, or 5.

11. Apparatus for monitoring a system remotely, including the components described in claims 1, 2, 3, 4, or 5.

12. A method of controlling a system remotely, including using the system of claim 1.

13. Apparatus for controlling a system remotely, including the components described in claim 1.

14. The system of claims 1, 2, 3, 4, or 5, in which said cellular telephone includes a local display of information relevant to the monitored or controlled system.

15. The system of claim 1, in which said cellular telephone includes an input mechanism such as a keypad for interacting with the monitored or controlled system.

16. A method of monitoring a system remotely including the steps of:
providing a communication system comprising: a sensor/controller device, a cellular telephone, a network, and communication apparatus; wherein said cellular telephone is configured to communicate with said sensor/controller and said network; monitoring a system other than said communication system by communicating between said sensor/controller device and said network; including facilitating communication between said sensor/controller device and said cellular telephone using said communication apparatus.
